(19) United States
(12) Patent Application Publication
(10) Pub. No.: US 2013/0112166 A1
(43) Pub. Date: May 9, 2013

(54) THRUST BEARING ASSEMBLY FOR ENGINE BLOCK

(71) Applicant: Jae Kwon Lee, Hwaseong-si (KR)

(72) Inventor: Jae Kwon Lee, Hwaseong-si (KR)

(73) Assignees: Kia Motors Corporation, Seoul (KR); Hyundai Motor Company, Seoul (KR)

(21) Appl. No.: 13/341,101

(22) Filed: Dec. 30, 2011

(30) Foreign Application Priority Data
Nov. 4, 2011 (KR) 10-2011-0114696

(51) Int. Cl. F02F 7/00; F16C 9/02

(52) U.S. Cl. 123/195 R

(57) ABSTRACT

A thrust bearing assembly for an engine block is disclosed. The engine block 100 has through-holes 110 formed in the center thereof, an insertion groove 120 formed in a circumferential direction along the bottom surface of each through-hole 110, and a locking groove 121 formed at one end of the insertion groove 120. A thrust bearing is inserted into the insertion groove 121 of the engine block 100, and is formed in a semicircular shape. The thrust bearing has a locking portion 201 at one end thereof which is inserted into the locking groove 121. The number of the thrust bearings can be reduced to cut costs, and the thrust bearings can be easily assembled to the engine block to improve the durability.

### CROSS-REFERENCE TO RELATED APPLICATION

This application is based on and claims priority from Korean Patent Application No. 10-2011-0114696, filed on Nov. 4, 2011 in the Korean Intellectual Property Office, the disclosure of which is incorporated herein in its entirety by reference.

### BACKGROUND OF THE INVENTION

1. Field of the Invention

The present invention relates to a thrust bearing assembly for an engine block, and more particularly, to a thrust bearing assembly capable of easily assembling thrust bearings to an engine block.

2. Description of the Prior Art

In general, a crankshaft for used in vehicles is provided with a plurality of crank pins, each crank pin being connected to the lower end of a connecting rod, and a journal, positioned between the crank pins located at a desired interval, for reliably supporting the crankshaft in a cylinder block. A balancing weight is provided at a crank arm to maintain the balance of the crankshaft upon rotation.

In the course of assembling the crankshaft having the above-described configuration to the cylinder block of the engine, the journals provided along its length are enclosed by several bearings each consisting of upper and lower semicircular halves which are segmented in a longitudinal direction. The bearing is provided to the journal of the crankshaft, for the sake of forming a proper oil film on the surface of the bearing to absorb a high load or shock applied to a rotating portion at a power stroke, converting solid friction, which is caused by rotation of the crankshaft, into fluid friction to prevent contact surfaces from being stuck to each other, and reducing the wear of the contact surfaces or the loss of output.

Meanwhile, thrust bearings are provided on both sides of a main bearing covering the intermediate journal of the crankshaft to dampen the axial load of the crankshaft.

FIG. 1 is a view illustrating a thrust bearing assembly for the engine block in the related art.

The conventional thrust bearing assembly for the engine block generally includes, as shown in FIG. 1, an engine block 10 with a through-hole 11 formed in the center thereof, a crank 21 which is formed in the shape of semicircular ring and is inserted into the through-hole 11 of the engine block 10, and thrust bearings 20 mounted on both sides of the crank 21.

In the conventional thrust bearing assembly, the crank 21 and the thrust bearings 20 are integrally formed in order to easily assemble the thrust bearings 20 to the engine block 10. However, if the crank 21 and the thrust bearings 20 are provided in a single body, there is a problem in that the rotation of the thrust bearing 20 is interfered in the engine block 10, so that it is difficult to configure the support structure.

### SUMMARY OF THE INVENTION

Accordingly, the present invention has been made to solve the above-mentioned problems occurring in the prior art while advantages achieved by the prior art are maintained intact.

One subject to be achieved by the present invention is to provide a thrust bearing assembly for an engine block which can easily assembling the thrust bearings to the engine block in a state in which the engine block is separated from the thrust bearings.

In one aspect of the present invention, there is provided a thrust bearing assembly for an engine block, which includes the engine block having a through-hole formed in a center thereof, an insertion groove formed in a circumferential direction along the through-hole, and a locking groove formed at one end of the insertion groove; and a thrust bearing formed in a semicircular shape and inserted into the insertion groove of the engine block, the thrust bearing having a locking portion at one end thereof which is inserted into the locking groove.

It is preferable that the thrust bearing has a circumferential surface of 190 degrees.

In addition, it is preferable that a crank of a semicircular ring is inserted into the through-hole of the engine block, and the thrust bearing is positioned at the crank.

With the above configuration, the number of the thrust bearings can be reduced to cut costs, and the thrust bearings can be easily assembled to the engine block to improve the durability.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a thrust bearing assembly for an engine block in the related art;

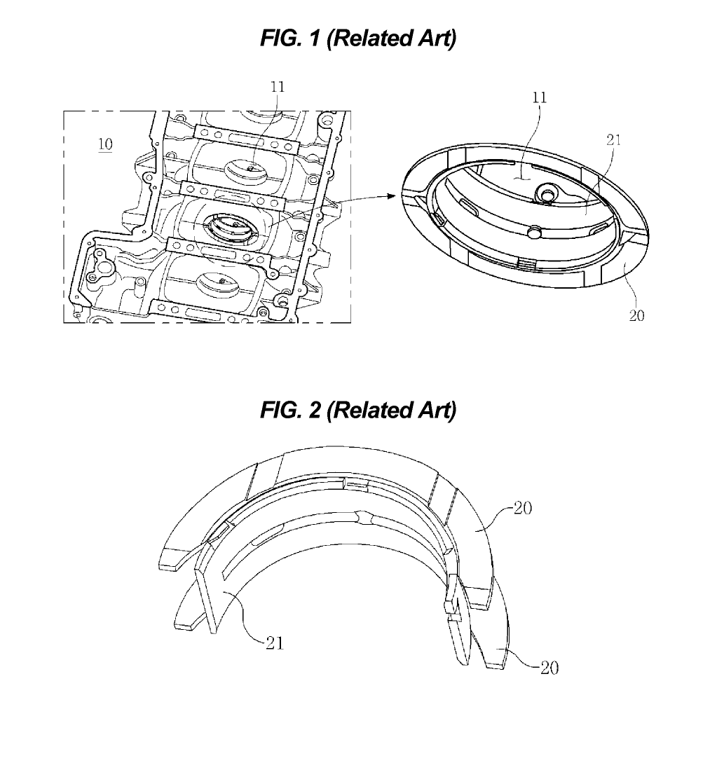

FIG. 2 is a view illustrating a unitary thrust bearing in a thrust bearing assembly for an engine block in ₜhe related art;

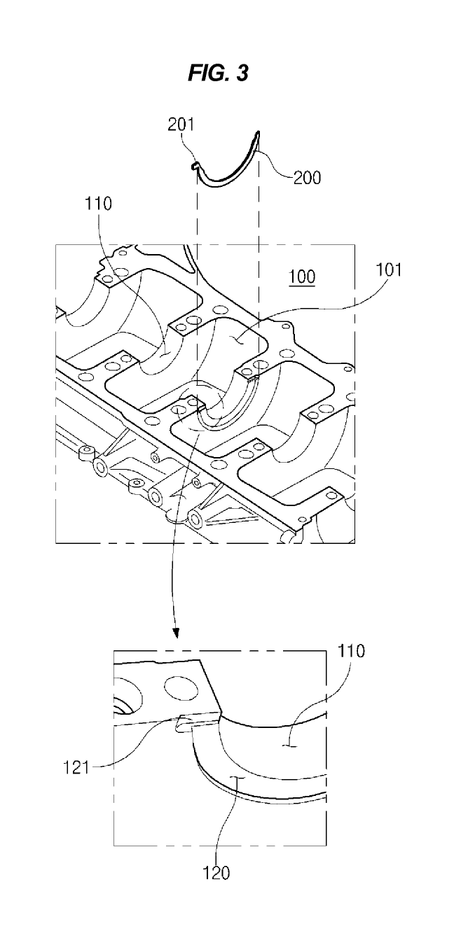

FIG. 3 is a view illustrating a thrust bearing assembly for an engine block according to the present invention; and

FIGS. 4A to 4D are views illustrating a process of assembling an engine block and a thrust bearing in the thrust bearing assembly for the engine block according to the present invention.

### DETAILED DESCRIPTION OF THE PREFERRED EMBODIMENTS

Hereinafter, preferred embodiments of the present invention will be described with reference to the accompanying drawings. In the entire description of the present invention, the same drawing reference numerals are used for the same elements across various figures.

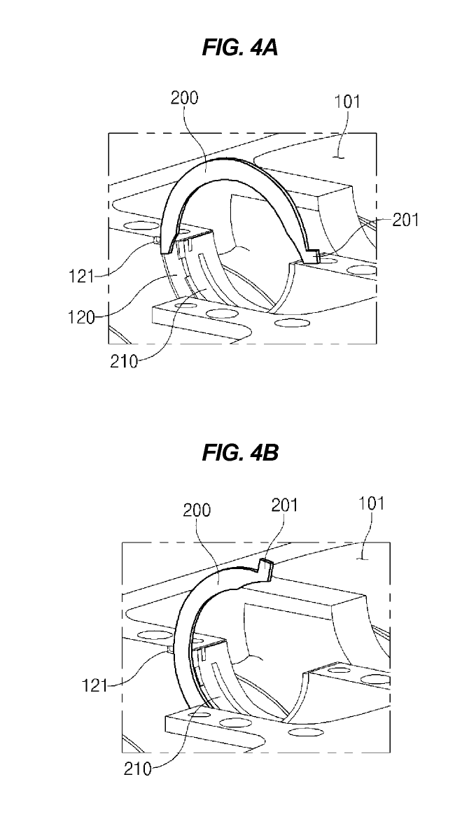

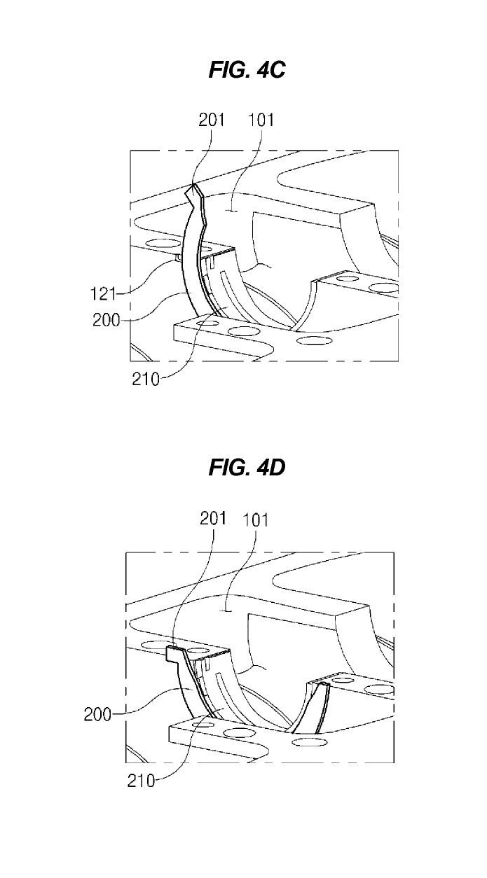

FIGS. 3 and 4A to 4D show a thrust bearing assembly for an engine block according to the present invention. Specifically, FIG. 3 is a view illustrating the thrust bearing assembly for the engine block according to the present invention, and FIGS. 4A to 4D are views illustrating a process of assembling the thrust bearing to the engine block in the thrust bearing assembly for the engine block according to the present invention.

The thrust bearing assembly according to the present invention includes, as shown in FIGS. 3 and 4A to 4D, an engine block 100 provided with insertion grooves 120 and locking grooves 121, and thrust bearings 200 formed in the semicircular shape. With the configuration, each of the thrust bearings 200 is inserted into the insertion groove 120, and the locking portion 201 of each thrust bearing 200 is locked to the locking groove 121, which can reduce the number of the thrust bearings 200 and can easily assemble the thrust bearings 200 to the engine block 100, as compared with the related art.

Each component of the thrust bearing assembly for the engine block according to the present invention will now be described with reference to the accompanying drawings.

First, as shown in FIG. 3, according to the present invention, the engine block 100 is provided with through-holes 110 at the center thereof, and the thrust bearings 200 are inserted into the engine block 100 via the through-holes.

The engine block 100 includes a plurality of blocks 101, and the through-hole 110 is formed in the center of each block 101.

Each insertion groove 120 is formed in a circumferential direction along the bottom surface of each through-hole 110 of the engine block 100, and each locking groove 121 is formed at one end of each insertion groove 120.

It is preferable that the depth of the insertion groove 120 is determined to correspond to the thickness of the thrust bearing 200 which will be described below.

Each of the thrust bearings 200 is formed in the semicircular shape, and is inserted into each insertion groove 120 of the engine block 100. It is preferable that the insertion groove 120 is formed in the semicircular shape to correspond to the thrust bearing 200.

In this instance, each of the thrust bearings 200 is provided with the locking portion 201 at one end thereof. When the thrust bearing 200 is inserted into the insertion groove 120 of the engine block 100, each of the locking portions is locked to the locking groove 121 of the insertion groove 120, thereby causing the thrust bearings 200 to rotate in one direction at the time of operation of the engine.

It is preferable that the thrust bearing 200 of the semicircular shape has a circumferential surface of 190 degrees, so that the locking portion 201 formed at one end of the thrust bearing 200 can be locked to the locking groove 121 of the insertion groove 120 to improve the support force.

Meanwhile, it is preferable that each crank 210 of a semicircular ring is inserted into the through-hole 110 formed in the block 101 of the engine block 100, so that the thrust bearing 200 inserted into the insertion groove 120 of the through-hole 110 is positioned at forward-backward of bottom or forward-backward of bottom of top at the each crank 210.

The operation and effect of the present invention will now be described.

As shown in FIG. 3, the thrust bearing assembly includes the engine block 100 provided with the insertion grooves 120 and the locking grooves 121, and the semicircular thrust bearings 200, in which each of the thrust bearings 200 is inserted into each insertion groove 120, and the locking portion 201 of the thrust bearing 200 is locked to the locking groove 121.

With the thrust bearing assembly according to the present invention, as shown in FIG. 4A, each crank 210 is mounted to each through-hole 110 of the engine block 100, and then each thrust bearing 200 is positioned on each insertion groove 120 of the engine block 100.

One end, on which the locking portion 201 is not formed, of the thrust bearing 200 is inserted into the insertion groove 120, on which the locking groove 121 is formed, of the engine block 100.

As shown in FIGS. 4B and 4C, the thrust bearing 200 is rotated along the insertion groove 120 of the engine block 100. The thrust bearing 200 has the circumferential surface of 190 degrees, so that the locking portion 201 of the thrust bearing 200 can be locked to the locking groove 121 of the insertion groove 120 to improve the support force.

As a result, as shown in FIG. 4D, if the thrust bearing 200 is turned by a half rotation, the locking portion 201 of the thrust bearing 200 is seated on the locking groove 121 of the engine block 100, thereby easily assembling the thrust bearing 200 to the engine block 100.

The thrust bearing assembly for the engine block according to the present invention includes the engine block provided with through-holes formed in the center thereof, the insertion groove formed in the circumferential direction along the bottom surface of the through-hole, and the locking groove formed at one end of the insertion groove, and the thrust bearings inserted into the insertion groove of the engine block, and the thrust bearing being formed in the semicircular shape and having the locking portion at one end thereof which is inserted into the locking groove. With the above configuration, the present invention can reduce the number of the thrust bearings to cut costs, and easily assemble the thrust bearings to the engine block to improve the durability.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A thrust bearing assembly for an engine block, comprising:
the engine block having a through-hole formed in a center thereof, an insertion groove formed in a circumferential direction along the through-hole, and a locking groove formed at one end of the insertion groove; and
a thrust bearing formed in a semicircular shape and inserted into the insertion groove of the engine block, the thrust bearing having a locking portion at one end thereof which is inserted into the locking groove.

2. The thrust bearing assembly according to claim 1, wherein the thrust bearing has a circumferential surface of 190 degrees.

3. The thrust bearing assembly according to claim 1, wherein a crank of a semicircular ring is inserted into the through-hole of the engine block, and the thrust bearing is positioned at the crank.

4. The thrust bearing assembly according to claim 1, wherein the insertion groove is formed in a semicircular shape to correspond to the thrust bearing.
